(19) United States
(12) Patent Application Publication
(10) Pub. No.: US 2025/0385032 A1
(43) Pub. Date: Dec. 18, 2025

(54) APPARATUS HAVING AN INDUCTOR AND A HIGH THERMAL CONDUCTIVITY FRAME AND MANUFACTURING METHOD THEREOF

(71) Applicant: Richtek Technology Corporation, Zhubei City (TW)

(72) Inventors: Shih-Chieh Lin, Kaohsiung (TW); Heng-Chi Huang, Hsinchu (TW); Lung-Sheng Lin, Hsinchu (TW); Yong-Zhong Hu, Hsinchu (TW)

(21) Appl. No.: 19/008,089

(22) Filed: Jan. 2, 2025

Related U.S. Application Data
(60) Provisional application No. 63/660,672, filed on Jun. 17, 2024.

(30) Foreign Application Priority Data
Nov. 22, 2024 (TW) 113145207

(51) Int. Cl. H01F 27/22; H01F 27/06; H01F 27/255; H01F 41/02

(52) U.S. Cl. CPC H01F 27/22; H01F 27/06; H01F 27/255; H01F 41/0206

(57) ABSTRACT

The present invention provides an apparatus having an inductor and a high thermal conductivity frame, and a manufacturing method thereof. The apparatus comprises: an inductor having at least two internal conductors, the inductor being embedded in magnetic powder material; and a frame made of a high thermal conductivity material, the frame including a top plate located above the at least two internal conductors, bottom plate located below the at least two internal conductors, and at least one connecting bar between the top plate and the bottom plate, with the frame embedded within the magnetic powder material; wherein the apparatus is disposed above an electronic component and is in contact with the electronic component through the bottom plate of the frame.

### CROSS REFERENCE

The present invention claims priority to US 63/660,672filed on Jun. 17, 2024, and claims priority to TW 113145207 filed on Nov. 22, 2024.

### BACKGROUND OF THE INVENTION

### Field of Invention

The present invention relates to an apparatus having an inductor and a thermal high conductivity frame and a manufacturing method thereof. In particular, it relates to such an apparatus having an inductor and a high thermal conductivity frame and a manufacturing method thereof, which enhance thermal conductivity by embedding the frame in magnetic powder material to contact an electronic component.

### Description of Related Art

As shown in FIG. 1, U.S. Pat. No. 11,770,916 discloses an inductor structure 1, wherein a metallic band 3 made of a high thermal conductivity material is wrapped around the exterior portion of the inductor. The metallic band 3 aims to enhance heat transfer between the inductor and an integrated circuit (IC) chip, thereby improving heat dissipation efficiency. The metallic band 3 may be made of high thermal conductivity materials such as copper, silver, or aluminum, and its width can be adjusted as required to ensure effective thermal contact with the underlying IC chip.

However, this prior art has several notable drawbacks. First, the metallic band 3 is installed by wrapping it around the inductor after the inductor is manufactured. Due to the need to bend the metallic band 3 precisely to fit the shape of the inductor, it is challenging to ensure perfect contact between the metallic band 3 and the surface of the inductor during manufacturing. Particularly at the bends, achieving an exact 90-degree angle is difficult, resulting in uneven or excessive gaps between the metallic band 3 and the inductor, which negatively impacts thermal conductivity efficiency.

Second, thermal interface material (TIM) is required to connect the metallic band 3 to the inductor. Since the thermal conductivity of TIM is relatively low (typically 1-2 W/m·K), and gaps exist at the starting and ending points of the metallic band 3, the overall thermal resistance increases, further reducing thermal transfer efficiency. Additionally, because the metallic band 3 primarily surrounds the sides of the inductor, heat must travel along a longer path, increasing thermal resistance and lengthening the heat transfer pathway from the IC chip to the heat sink, thereby degrading the heat dissipation performance.

Lastly, heat from the middle portion of the inductor is difficult to transfer effectively and promptly to the metallic band 3, primarily relying on vertical thermal conduction. However, multiple layers of materials and interfaces, such as TIM and magnetic powder material, exist in the vertical direction, adding thermal resistance and limiting overall heat dissipation performance. These deficiencies restrict the prior art's ability to perform efficiently in heat dissipation, necessitating improvement.

In view of the aforementioned issues, the present invention provides an apparatus having an inductor and a high thermal conductivity frame and a manufacturing method thereof, which significantly enhances heat dissipation through a simple manufacturing process.

### SUMMARY OF THE INVENTION

From one perspective, the present invention provides an apparatus having an inductor and a high thermal conductivity frame, comprising: an inductor having at least two internal conductors, the inductor being embedded in a first magnetic powder material; and a frame made of a high thermal conductivity material, the frame including a top plate located above the at least two internal conductors, a bottom plate located below the at least two internal conductors, and at least one vertical frame between the top plate and the bottom plate, the frame being embedded within the first magnetic powder material; wherein the apparatus is disposed above an electronic component and is in contact with the electronic component through the bottom plate of the frame.

In one embodiment, one of the at least one vertical frame includes one of the following forms: the vertical frame is connected between the top plate and the bottom plate, and the vertical frame, the top plate, and the bottom plate are integrally formed; the vertical frame includes a connecting bar, the connecting bar being connected between the top plate and the bottom plate; the vertical frame includes an upper vertical frame integrally formed with the top plate and a lower vertical frame integrally formed with the bottom plate, wherein the upper vertical frame and the lower vertical frame are either directly connected or separated by a gap, the gap being less than one-fourth of a vertical distance between the top plate and the bottom plate; the vertical frame includes an upper vertical frame integrally formed with the top plate and a lower vertical frame integrally formed with the bottom plate, wherein the upper vertical frame and the lower vertical frame are connected by a connecting bar; wherein the connecting bar is made of a high thermal conductivity material.

In one embodiment, the high thermal conductivity material is a formable metal, including steel, copper, silver, gold, aluminum, tungsten, zinc, or stainless steel.

In one embodiment, the high thermal conductivity material is a non-metallic material, including aluminum nitride, silicon carbide, or graphite.

In one embodiment, the frame is coplanar with or does not extend beyond the surface of the first magnetic powder material of the inductor.

In one embodiment, the frame extends beyond the surface of the first magnetic powder material of the inductor.

In one embodiment, the surface of the top plate is optionally connected to a high thermal conductivity object through a thermal interface material to enhance heat dissipation.

In one embodiment, the electronic component includes an integrated circuit chip, an inductor, a capacitor, or a resistor.

In one embodiment, a side of the frame is optionally connected to at least one high thermal conductivity object for heat dissipation.

In one embodiment, the at least one high thermal conductivity object is directly connected to the top plate or the bottom plate.

In one embodiment, the frame is embedded within the magnetic powder material, and the top plate, bottom plate, and vertical frame of the frame are directly in contact with the first magnetic powder material without using a thermal interface material.

In one embodiment, the frame is manufactured through a single molding process, with the top plate, bottom plate, and vertical frame directly bonded to the first magnetic powder material under high temperature and high pressure.

In one embodiment, the frame includes multiple vertical frames connecting the top plate and the bottom plate to enhance structural strength.

In one embodiment, the internal conductor of the inductor is a clip structure to reduce direct current resistance.

In one embodiment, the length or width of the top plate and the bottom plate of the frame are optionally to be the same or different to optimize heat dissipation performance.

In one embodiment, the vertical frame is located in the middle portion of the inductor, contacting the top plate and the bottom plate, and providing a heat conduction path to transfer heat from the middle portion of the inductor to the top plate and the bottom plate.

In one embodiment, the frame is directly embedded within the first magnetic powder material during the manufacturing process of the inductor, without using a metallic sheet to cover the inductor after its formation, thereby avoiding uneven or excessive gaps caused during the covering process and improving heat dissipation performance.

In one embodiment, the apparatus having an inductor and a high thermal conductivity frame further comprises: a second magnetic powder material, the second magnetic powder material covering the external structure of the first magnetic powder material, the internal conductors, and the frame.

In one embodiment, the first magnetic powder material and the second magnetic powder material are two different magnetic powders, the first magnetic powder material being used to determine inductance of the inductor, and the second magnetic powder material being used for outer layer protection and heat dissipation.

From another perspective, the present invention provides a method for manufacturing an apparatus having an inductor and a high thermal conductivity frame, the apparatus including an inductor having at least two internal conductors, and a frame made of a high thermal conductivity material, the frame including a top plate located above the at least two internal conductors, a bottom plate located below the at least two internal conductors, and at least one vertical frame between the top plate and the bottom plate, the frame being embedded in a magnetic powder material and directly in contact with the magnetic powder material; the method comprising: (a) providing the at least two internal conductors and the frame; (b) placing the at least two internal conductors and the frame in a first mold, positioning the at least two internal conductors with the top plate, the bottom plate, and the vertical frame of the frame at predetermined positions; (c) adding a first magnetic powder material into the first mold, filling the first magnetic powder material between the frame and the internal conductors; (d) performing high-temperature and high-pressure treatment on the first mold, integrally forming the first magnetic powder material, the internal conductors, and the frame into a structure embedded within the first magnetic powder material; and (e) removing the formed structure from the first mold to produce the apparatus having an inductor and a high thermal conductivity frame.

In one embodiment, in step (a), the internal conductor is a clip structure to reduce direct current resistance.

In one embodiment, the aforementioned method for manufacturing an apparatus having an inductor and a high thermal conductivity frame further comprises: (f) placing the structure in a second mold, positioning the structure at a predetermined position; (g) adding a second magnetic powder material into the second mold, filling the second magnetic powder material around the structure; and (h) performing high-temperature and high-pressure treatment on the second mold to integrally form the second magnetic powder material and the structure, thereby producing the apparatus having an inductor and a high thermal conductivity frame.

In one embodiment, in step (d), the frame is directly bonded to the first magnetic powder material without using a thermal interface material.

In one embodiment, after step (e), the top surface of the inductor is connectable to a high thermal conductivity object through a thermal interface material.

From another perspective, the present invention provides a method for manufacturing an apparatus having an inductor and a high thermal conductivity frame, the apparatus including an inductor having at least two internal conductors, and a frame made of a high thermal conductivity material, the frame including a top plate located above the at least two internal conductors, a bottom plate located below the at least two internal conductors, and at least one vertical frame between the top plate and the bottom plate, the frame being embedded in a magnetic powder material and directly in contact with the magnetic powder material; the method comprising: (a) manufacturing at least two separate sub-inductors, each having at least one internal conductor embedded in a first magnetic powder material; (b) providing the frame; and (c) assembling the at least two sub-inductors into the frame, positioning the top plate and the bottom plate on the upper and lower sides of the at least two sub-inductors, respectively, to form a structure, thereby producing the apparatus having an inductor and a high thermal conductivity frame.

In one embodiment, the aforementioned method for manufacturing an apparatus having an inductor and a high thermal conductivity frame further comprises: (d) placing the structure in a mold, positioning the structure at a predetermined position; (e) adding a second magnetic powder material into the mold, filling the second magnetic powder material around the structure; and (f) performing high-temperature and high-pressure treatment on the mold to integrally form the second magnetic powder material and the structure, thereby producing the apparatus having an inductor and a high thermal conductivity frame.

In one embodiment, in step (c), the frame is connected to at least two sub-inductors through an adhesive or a thermal interface material.

The present invention provides significant advantages over the prior art. By embedding the high thermal conductivity frame directly into the magnetic powder material of the inductor during the manufacturing process, this invention avoids the challenges associated with covering the inductor with a metallic band after its formation. This design eliminates uneven or excessive gaps and greatly improves thermal conduction efficiency.

Furthermore, the frame structure of the present invention includes a top plate positioned above the internal conductors of the inductor, a bottom plate positioned below the internal conductors, and at least one vertical frame located in the middle portion, connecting the top plate and the bottom plate. This design provides a direct heat conduction path, efficiently transferring heat generated in the middle portion of the inductor and the electronic component to the top plate and bottom plate, and subsequently dissipating the heat to the external environment. Compared to the prior art, where heat follows a longer and more complex path via metallic bands on the sides to reach the heat sink, this invention significantly shortens the heat conduction path, reduces thermal resistance, and enhances heat dissipation performance.

Moreover, since the frame is directly integrated with the magnetic powder material during the manufacturing process, there is no need for a thermal interface material (TIM) to connect the metal and the inductor. This not only simplifies the manufacturing process but also avoids the increased thermal resistance typically caused by the relatively low thermal conductivity of TIM (commonly 1 to 2 W/m·K). In prior art, the connection of metallic bands to the inductor required TIM, and unavoidable gaps during manufacturing further limited thermal conduction efficiency. The present invention achieves more efficient heat transfer through a one-step molding process that directly bonds the frame to the magnetic powder material under high temperature and high pressure.

In summary, the present invention addresses the deficiencies of the prior art in terms of manufacturing complexity, heat conduction path, thermal resistance, and heat dissipation efficiency. Through innovative structural design and manufacturing methods, the invention provides a more effective thermal management solution, particularly suited for high-power-density and high-heat electronic components, enhancing the reliability and performance of the device.

The objectives, technical details, features, and effects of the present invention will be better understood with regard to the detailed description of the embodiments below, with reference to the attached drawings.

### BRIEF DESCRIPTION OF THE DRAWINGS

FIG. 1 is a schematic diagram of an inductor structure disclosed in prior art, U.S. Pat. No. 11,770,916.

FIGS. 2A, 2B, and 2C are schematic diagrams showing an apparatus having an inductor and a high thermal conductivity frame according to various embodiments of the present invention.

FIG. 3 is a schematic diagram showing an apparatus having an inductor and a high thermal conductivity frame according to an embodiment of the present invention.

FIG. 4 is a schematic diagram showing an apparatus having an inductor and a high thermal conductivity frame according to an embodiment of the present invention.

FIG. 5 is a schematic diagram showing an apparatus having an inductor and a high thermal conductivity frame according to an embodiment of the present invention.

FIG. 6 is a schematic diagram showing an apparatus having an inductor and a high thermal conductivity frame according to an embodiment of the present invention.

FIG. 7 is a schematic diagram showing an apparatus having an inductor and a high thermal conductivity frame according to an embodiment of the present invention.

FIG. 8 is a schematic diagram showing an apparatus having an inductor and a high thermal conductivity frame according to an embodiment of the present invention.

FIG. 9 is a schematic diagram showing an apparatus having an inductor and a high thermal conductivity frame according to an embodiment of the present invention.

FIG. 10 is a schematic diagram showing an apparatus having an inductor and a high thermal conductivity frame according to an embodiment of the present invention.

FIG. 11 is a schematic diagram showing an apparatus having inductor and a high thermal conductivity frame according to an embodiment of the present invention.

FIG. 12 is a schematic diagram showing an apparatus having an inductor and a high thermal conductivity frame according to an embodiment of the present invention.

FIG. 13 is a schematic diagram showing an apparatus having an inductor and a high thermal conductivity frame according to an embodiment of the present invention.

FIG. 14 is a schematic diagram showing an apparatus having an inductor and a high thermal conductivity frame according to an embodiment of the present invention.

FIG. 15 is a schematic diagram showing an apparatus having an inductor and a high thermal conductivity frame according to an embodiment of the present invention.

FIG. 16 is a schematic diagram showing an apparatus having an inductor and a high thermal conductivity frame according to an embodiment of the present invention.

FIG. 17 is a schematic diagram showing an apparatus having an inductor and a high thermal conductivity frame according to an embodiment of the present invention.

FIG. 18 is a schematic diagram showing an apparatus having an inductor and a high thermal conductivity frame according to an embodiment of the present invention.

FIG. 19 is a schematic diagram showing an apparatus having an inductor and a high thermal conductivity frame according to an embodiment of the present invention.

FIG. 20 is a schematic diagram showing an apparatus having an inductor and a high thermal conductivity frame according to an embodiment of the present invention.

FIG. 21 is a schematic diagram showing an apparatus having an inductor and a high thermal conductivity frame according to an embodiment of the present invention.

FIG. 22 is a schematic diagram showing an apparatus having an inductor and a high thermal conductivity frame according to an embodiment of the present invention.

FIG. 23 is a schematic diagram showing an apparatus having an inductor and a high thermal conductivity frame according to an embodiment of the present invention.

FIGS. 24A to 24D are schematic diagrams showing the manufacturing steps of an apparatus having an inductor and a high thermal conductivity frame (device 10) according to an embodiment of the present invention.

FIGS. 25A to 25C are schematic diagrams showing the manufacturing steps of an apparatus having an inductor and a high thermal conductivity frame (device 410) according to an embodiment of the present invention.

FIGS. 26A to 26C are schematic diagrams showing the manufacturing steps of an apparatus having an inductor and a high thermal conductivity frame (device 430) according to an embodiment of the present invention.

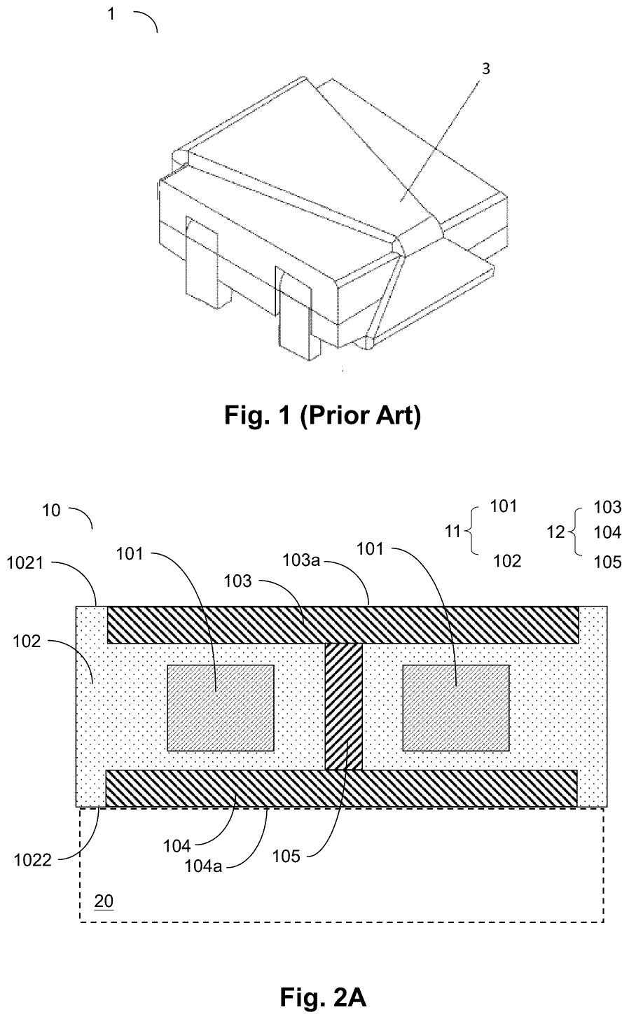

### DESCRIPTION OF THE PREFERRED EMBODIMENTS

The drawings as referred to throughout the description of the present invention are for illustration only, to show the interrelations among the process steps and the layers, while the shapes, thicknesses, and widths are not drawn in actual scale.

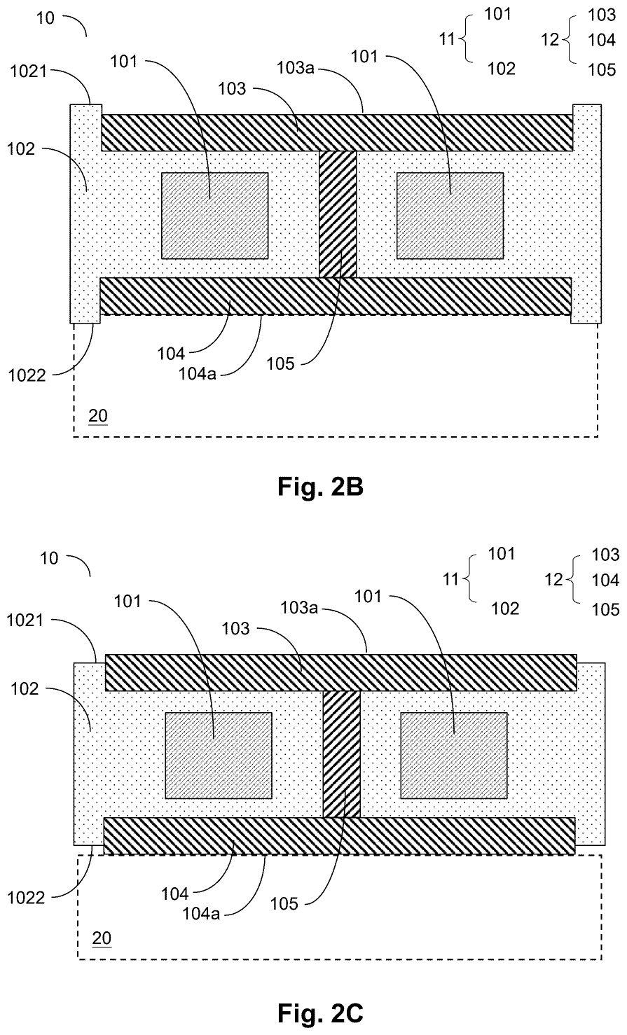

FIGS. 2A, 2B, and 2C are cross-sectional schematic diagrams of an apparatus having an inductor and a high thermal conductivity frame according to an embodiment of the present invention. As shown in FIG. 2A, the apparatus 10 includes an inductor 11 and a frame 12 made of a high thermal conductivity material. The inductor 11 comprises at least two internal conductors 101 embedded in a first magnetic powder material 102. The frame 12 includes a top plate 103 located above the internal conductors 101, a bottom plate 104 located below the internal conductors 101, and at least one vertical frame 105 connecting the top plate 103 and the bottom plate 104. The frame 12 is directly embedded within the first magnetic powder material 102.

Furthermore, the apparatus 10 is disposed above an electronic component 20 and makes contact with the component through the bottom plate 104 of the frame 12. This configuration effectively transfers heat generated by the electronic component 20 through the frame 12 to the top plate 103 and the bottom plate 104, significantly enhancing heat dissipation. In this embodiment, the vertical frame 105 of the frame 12 is located in the middle portion of the inductor 11, providing an efficient thermal conduction path to transfer heat from the middle portions of the electronic component 20 and the inductor 11 to the top plate 103 and bottom plate 104 of the frame 12. This design greatly improves thermal exchange efficiency and contributes to the overall heat dissipation performance of the apparatus.

In one embodiment, the top plate 103 and the bottom plate 104 of the frame 12 can optionally have identical or different lengths and widths to optimize heat dissipation.

In another embodiment, the internal conductors 101 of the frame 12 utilize a clip-type structure, which, compared to traditional coil-type inductors, further reduces the DC resistance of the inductor, enhancing its efficiency in high-current applications. Examples of this will be provided in subsequent embodiments.

In another embodiment, the apparatus 10 can be manufactured through a single molding process, where the top plate 103, bottom plate 104, and vertical frame 105 of the frame 12 are directly bonded with the first magnetic powder material 102 under high temperature and high pressure. This eliminates the need for thermal interface materials and resolves potential issues with thermal resistance during manufacturing, achieving optimized heat dissipation.

It should be noted that thermal interface materials (TIMs) are commonly used in electronic devices to fill gaps between heat-generating components and heat sinks. These materials improve thermal conductivity by reducing air gaps that can hinder heat transfer. TIMs are available in various forms, including thermal grease, pads, tapes, gels, and phase-change materials, with typical thermal conductivity values ranging from 1 to 2 W/m·K.

High thermal conductivity materials refer to materials with a thermal conductivity of at least 10 W/m·K, capable of efficiently transferring heat. In some electronic applications, materials with thermal conductivities above 100 W/m·K are preferred to meet heat dissipation requirements. Examples include metals like aluminum (˜240 W/m·K), copper (˜400 W/m·K), and silver (˜430 W/m·K), as well as non-metals such as aluminum nitride (AlN), silicon carbide (SiC), and graphite.

In one embodiment, the vertical frame 105 connects the top plate 103 and bottom plate 104 and is integrally formed with them.

In one embodiment, the frame 12 is in direct contact with the first magnetic powder material 102, eliminating the need for thermal interface materials.

In another embodiment, the top plate 103 and the bottom plate 104 are parallel to each other.

In another embodiment, the high thermal conductivity material can be a formable metal, such as steel, copper, silver, gold, aluminum, tungsten, zinc, or stainless steel.

In another embodiment, the high thermal conductivity material can be a non-metallic material, such as aluminum nitride, silicon carbide, or graphite.

As shown in FIG. 2A, the frame 12 and the inductor 11's first magnetic powder material 102 are coplanar, meaning that the top surface 103a of the top plate 103 aligns with the top surface 1021 of the first magnetic powder material 102, and the bottom surface 104a of the bottom plate 104 aligns with the bottom surface 1022 of the first magnetic powder material 102.

In another embodiment, as shown in FIG. 2B, the frame 12 does not extend beyond the top or bottom surfaces 1021 and 1022 of the first magnetic powder material 102.

In another embodiment, as shown in FIG. 2C, the frame 12 extends beyond the top and bottom surfaces 1021 and 1022 of the first magnetic powder material 102.

In one embodiment, the electronic component 20 may include an integrated circuit chip, an inductor, a capacitor, or a resistor.

In one embodiment, the frame 12 may include multiple vertical frames 105 connecting the top plate 103 and the bottom plate 104 to enhance structural strength.

In another embodiment, the frame 12 is directly embedded into the first magnetic powder material 102 during the manufacturing process, avoiding the use of metallic coverings applied after the inductor 11 is fabricated. This prevents uneven or excessive gaps, particularly at bends, that could degrade thermal performance. That is, the frame 12 is directly embedded within the first magnetic powder material 102 during the manufacturing process of the inductor, without using a metallic sheet to cover the inductor after its formation, thereby avoiding uneven or excessive gaps caused during a covering process and improving heat dissipation performance

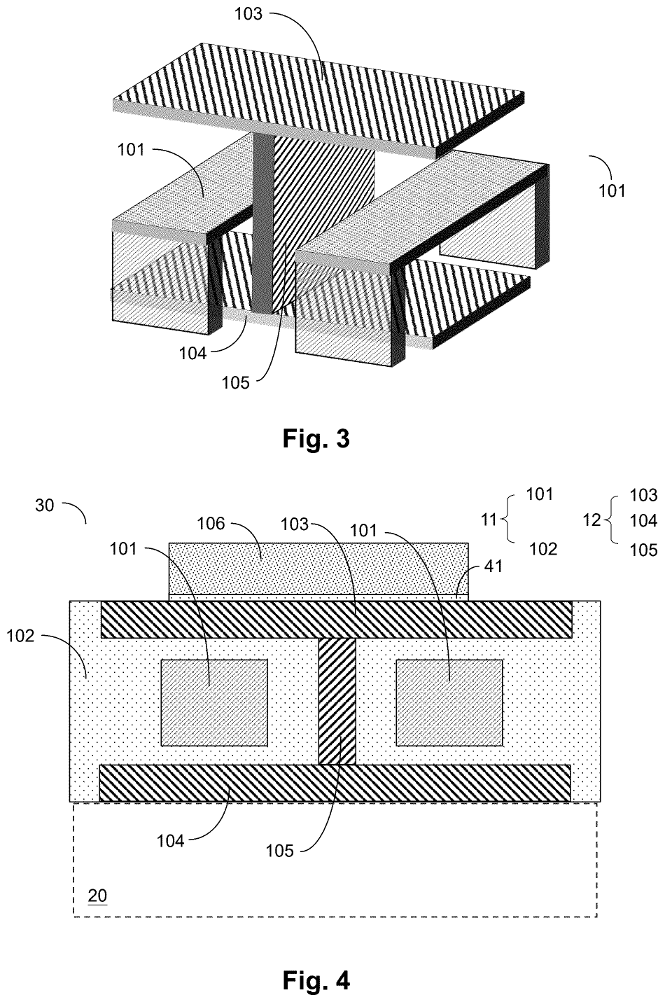

FIG. 3 illustrates a three-dimensional representation of the internal conductors 101 and the frame 12 shown in FIG. 2, further demonstrating the apparatus 10's structure with an inductor and a high thermal conductivity frame.

In this embodiment, the apparatus 10 includes the inductor 11 and the frame 12. The internal conductors 101 are embedded in the first magnetic powder material 102 (not shown in FIG. 3; refer to FIG. 2). The frame 12 comprises the top plate 103, bottom plate 104, and at least one vertical frame 105, forming a sturdy support structure. The clip-type design of the internal conductors 101, along with the top plate 103 and bottom plate 104, ensures efficient heat conduction and structural stability, further enhancing heat dissipation performance.

In this embodiment, the top plate 103 is a flat structure designed to contact other heat dissipation elements (e.g., heat sinks) to transfer heat generated by the electronic component 20 and the inductor 11 to the external environment. The vertical frame 105 directly spans and is fixed between the top plate 103 and the bottom plate 104. Positioned in the middle portion of the inductor, the vertical frame 105 provides a thermal conduction path, efficiently transferring heat from the interior of the inductor 11 to the top plate 103 and bottom plate 104, further enhancing heat dissipation performance.

FIG. 4 illustrates an embodiment of the present invention showing an apparatus 30 with an inductor and a high thermal conductivity frame. In this embodiment, the frame 12 includes a top plate 103, a bottom plate 104, and vertical frames 105 located between the top and bottom plates. The frame 12 can be in direct contact with the first magnetic powder material 102 or connected via a thermal interface material and is positioned above and below the internal conductors 101, providing structural support and thermal conduction paths.

As shown in FIG. 4, the surface of the top plate 103 is connected to a high thermally conductive object 106 via a layer of thermal interface material 41. The high thermally conductive object 106 may include, but is not limited to, a heat sink. The thermal interface material 41 fills the gap between the top plate 103 and the high thermally conductive object 106 to reduce contact thermal resistance, effectively transferring heat generated during the operation of the electronic component 20 and the inductor 11 to the high thermally conductive object 106. This design allows the high thermally conductive object 106 to rapidly dissipate heat generated by the inductor 11 and the electronic component 20, further improving the heat dissipation efficiency of the entire apparatus.

The high thermally conductive object 106 is made of a high thermal conductivity material, such as metals (e.g., copper, aluminum, silver, or gold), ceramics (e.g., aluminum nitride or silicon carbide), or composite materials. These materials enable rapid and effective heat transfer and are critical in thermal management applications, particularly in electronic devices or high-power components requiring efficient heat dissipation.

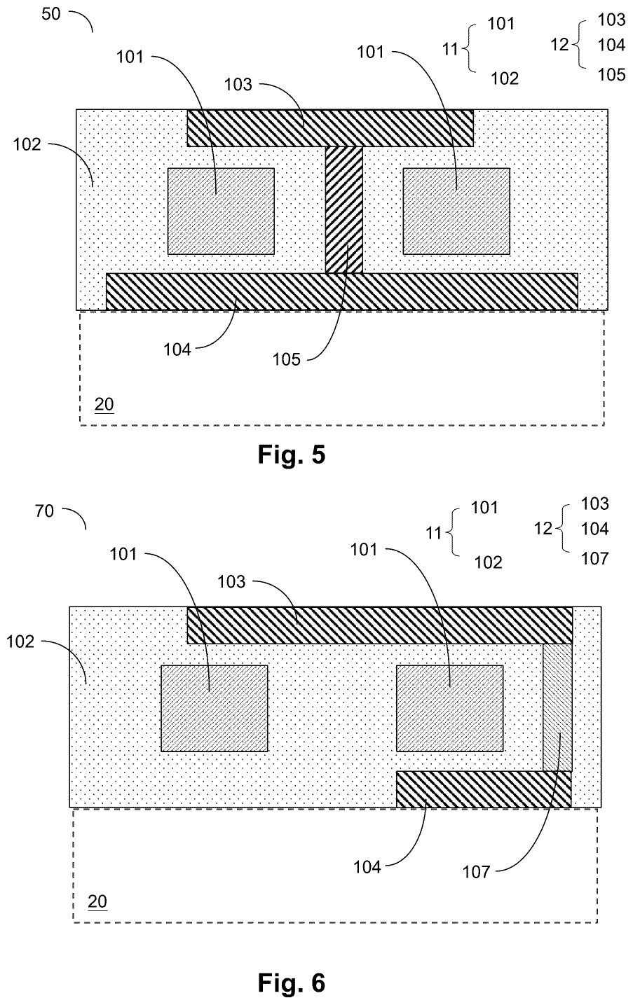

FIG. 5 illustrates an embodiment of the present invention, showing an apparatus 50 where the lengths of the top plate 103 and the bottom plate 104 differ. This embodiment demonstrates that the dimensions of the top plate 103 and the bottom plate 104, including length and width, can be customized to optimize heat dissipation.

FIG. 6 shows another embodiment of the present invention. In apparatus 70, the lengths of the top plate 103 and bottom plate 104 differ, and the vertical frame includes a connecting bar 107. The connecting bar 107 links the top plate 103 and the bottom plate 104 and may be positioned at the side of the inductor 11 rather than in its middle portion.

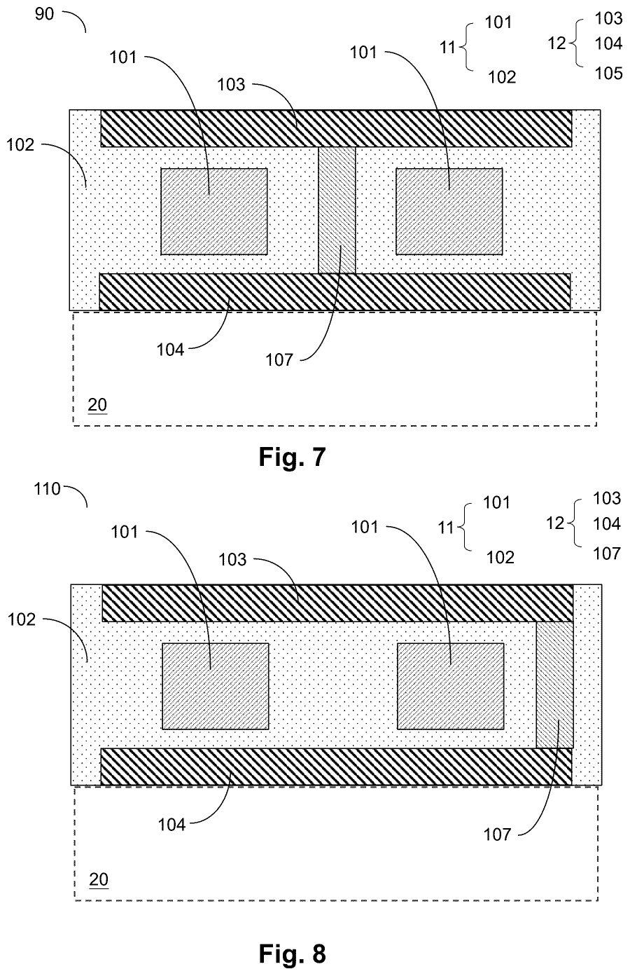

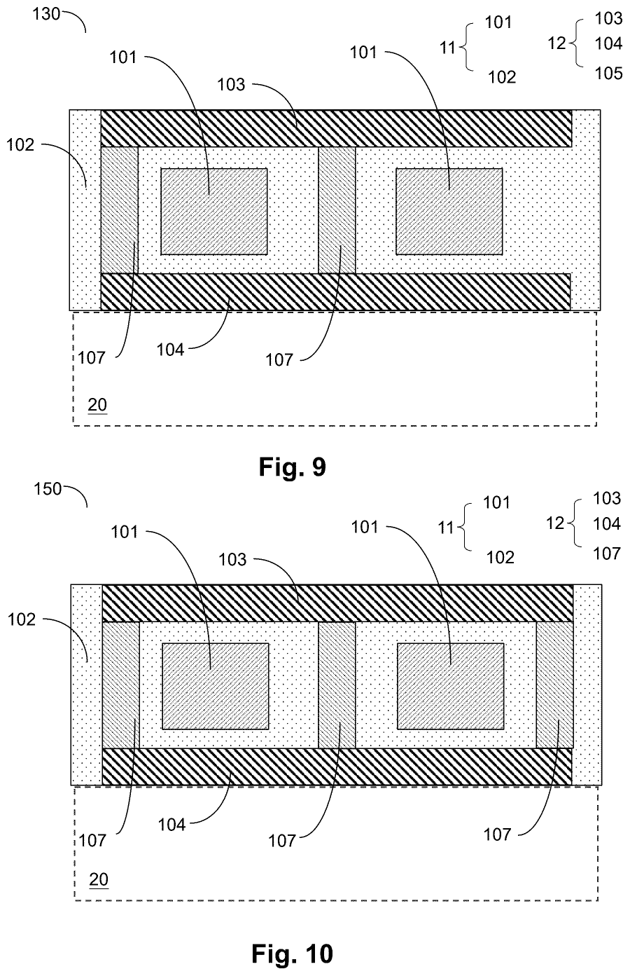

FIGS. 7, 8, 9, and 10 illustrate several embodiments of the present invention. In apparatuses 90, 110, 130, and 150, connecting bars 107 link the top plate 103 and the bottom plate 104. These embodiments feature variations in the number and positions of the connecting bars 107.

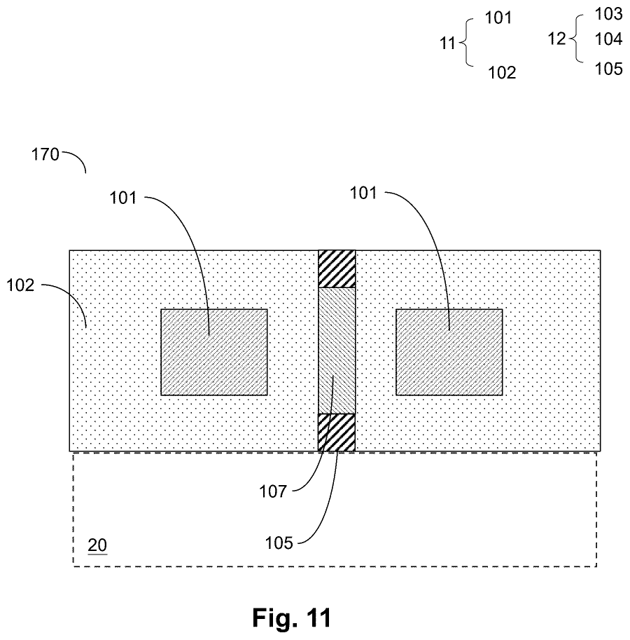

FIG. 11 illustrates an embodiment showing apparatus 170. In this embodiment, the lengths of the top plate 103 and bottom plate 104 do not exceed the vertical frame. The vertical frame includes a connecting bar 107, positioned in the middle portion of the inductor 11, connecting the top plate 103 and bottom plate 104.

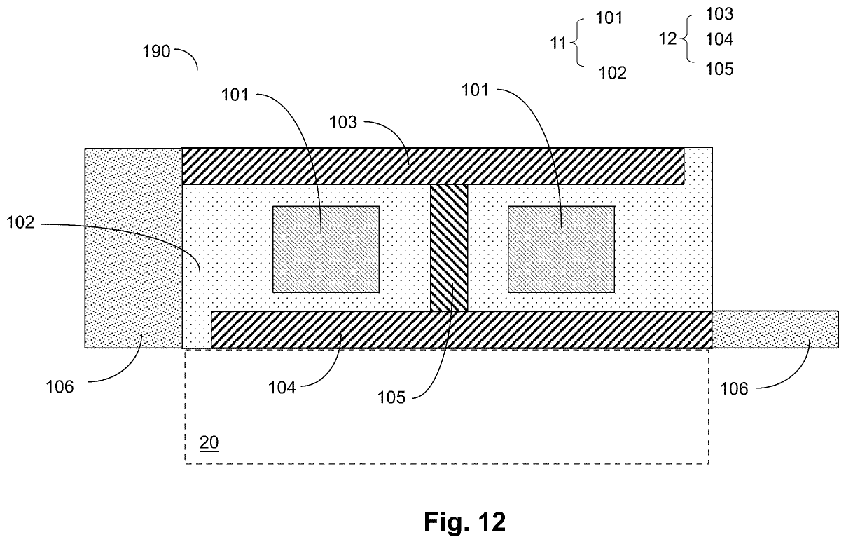

FIG. 12 illustrates an embodiment showing apparatus 190. The frame 12 consists of a top plate 103, a bottom plate 104, and a vertical frame 105 connecting the two. The frame 12 can directly contact or connect to the first magnetic powder material 102 via thermal interface materials and is positioned above and below the internal conductors 101, providing structural support and thermal conduction paths. The top plate 103, bottom plate 104, and vertical frame 105 may be integrally formed.

As shown in FIG. 12, the side surfaces of the frame 12 can connect to high thermally conductive objects 106 for heat dissipation. For example, the side surfaces of the top plate 103 and bottom plate 104 may each connect to a high thermally conductive object 106 via a thermal interface material layer. This design facilitates rapid heat dissipation, enhancing the apparatus's overall performance.

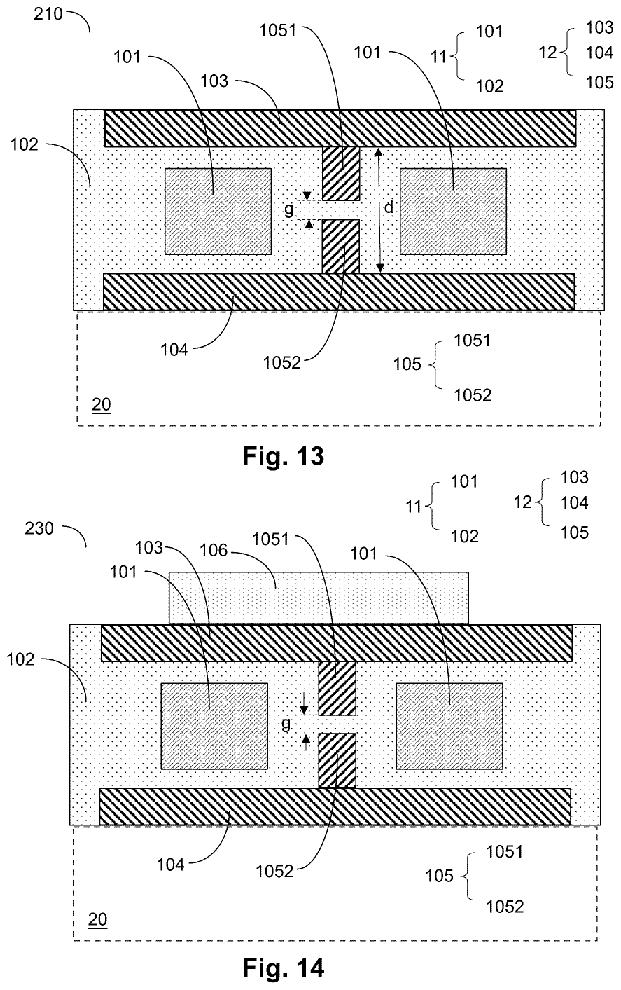

FIG. 13 shows an embodiment illustrating apparatus 210. The vertical frame 105 includes an upper vertical frame 1051 integrally formed with the top plate 103 and a lower vertical frame 1052 integrally formed with the bottom plate 104. The upper and lower vertical frames are separated by a gap g, where g is less than one-fourth of the vertical distance d between the top plate 103 and bottom plate 104.

FIG. 14 shows an embodiment illustrating apparatus 230. Similar to the embodiment in FIG. 13, the vertical frame 105 includes an upper vertical frame 1051 and a lower vertical frame 1052, separated by a gap g. However, in this embodiment, the surface of the top plate 103 is connected to a high thermally conductive object 106, such as a heat sink.

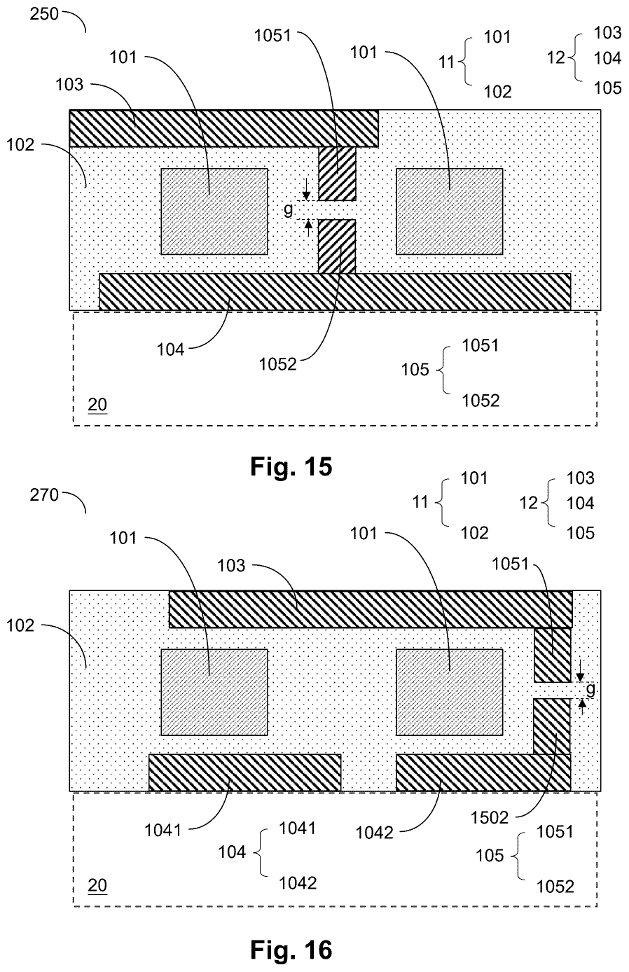

FIG. 15 shows an embodiment illustrating apparatus 250, where the top plate 103 and bottom plate 104 have different lengths, and the vertical frame 105 includes upper and lower portions separated by a gap g.

FIG. 16 shows apparatus 270, where the vertical frame 105 comprises upper and lower portions separated by a gap g. Unlike previous embodiments, the vertical frame portions are positioned on the side of the inductor 11 rather than the middle, and the bottom plate 104 includes two unconnected segments: a first bottom plate 1041 and a second bottom plate 1042.

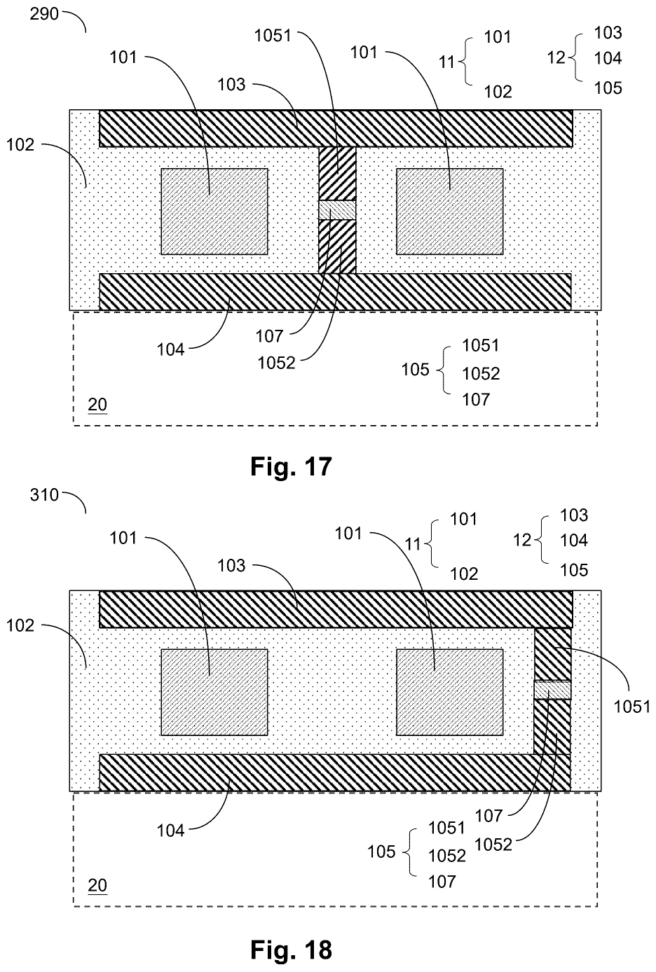

FIG. 17 shows apparatus 290, where the vertical frame 105 includes an upper vertical frame 1051, a lower vertical frame 1052, and a connecting bar 17 linking the two. The connecting bar 17 is made of a high thermal conductivity material, which may or may not be the same as the material used for the top plate 103, bottom plate 104, and vertical frames.

FIG. 18 illustrates an apparatus 310 having an inductor and a high thermal conductivity frame, according to an embodiment of the present invention. The frame 12 includes a top plate 103, a bottom plate 104, and a vertical frame 105 positioned between them. In this embodiment, the vertical frame 105 comprises an upper vertical frame 1051 integrally formed with the top plate 103, a lower vertical frame 1052 integrally formed with the bottom plate 104, and a connecting bar 17 linking the two. The connecting bar 17 is made of a high thermal conductivity material, which may or may not be the same as the material used for the top plate 103, bottom plate 104, and the vertical frames 1051 and 1052. Unlike the embodiment shown in FIG. 17, in this instance, the vertical frame 105 is positioned outside the middle portion of the inductor 11.

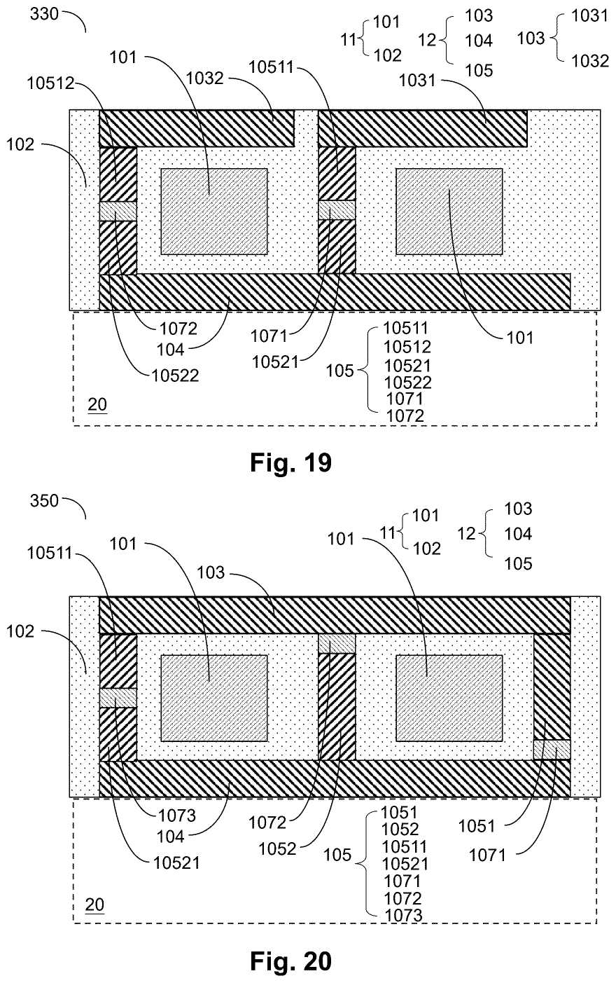

FIG. 19 shows an apparatus 330 according to another embodiment of the present invention. The frame 12 includes a top plate 103, a bottom plate 104, and a vertical frame 105 positioned between them. In this embodiment, the top plate 103 comprises two separate sections, a first top plate 1031 and a second top plate 1032. The vertical frame 105 includes a first upper vertical frame 10511 and first lower vertical frame 10521 connected by a first connecting bar 1071, as well as a second upper vertical frame 10512 and second lower vertical frame 10522 connected by a second connecting bar 1072. The first upper and lower vertical frames are positioned in the middle portion of the inductor 11, while the second upper and lower vertical frames are positioned away from the middle portion.

FIG. 20 illustrates an apparatus 350 according to an embodiment of the present invention, where the top plate 103, bottom plate 104, and vertical frame 105 exhibit enhanced configurations for improved heat dissipation and structural strength. The vertical frame 105 includes an upper vertical frame 1051 integrally formed with the top plate 103, a first connecting bar 1071 linking the upper vertical frame to the bottom plate 104, a lower vertical frame 1052 integrally formed with the bottom plate 104, and additional connecting bars 1072 and 1073. This configuration provides extra heat conduction paths and ensures structural stability under various operating conditions.

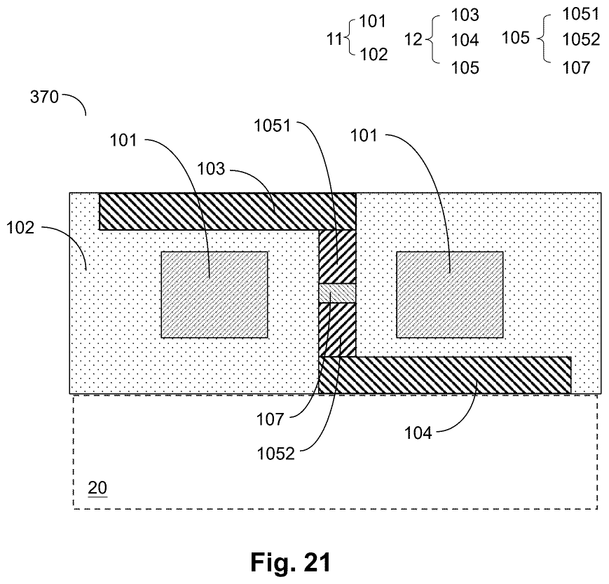

FIG. 21 shows an apparatus 370, where the frame 12 includes a top plate 103 positioned on the left side of the inductor 11 and a bottom plate 104 positioned on the right side. The vertical frame 105 includes an upper vertical frame 1051, a lower vertical frame 1052, and a connecting bar 17 linking them. This arrangement differs from the embodiment in FIG. 17, which has the frame centrally aligned with the inductor.

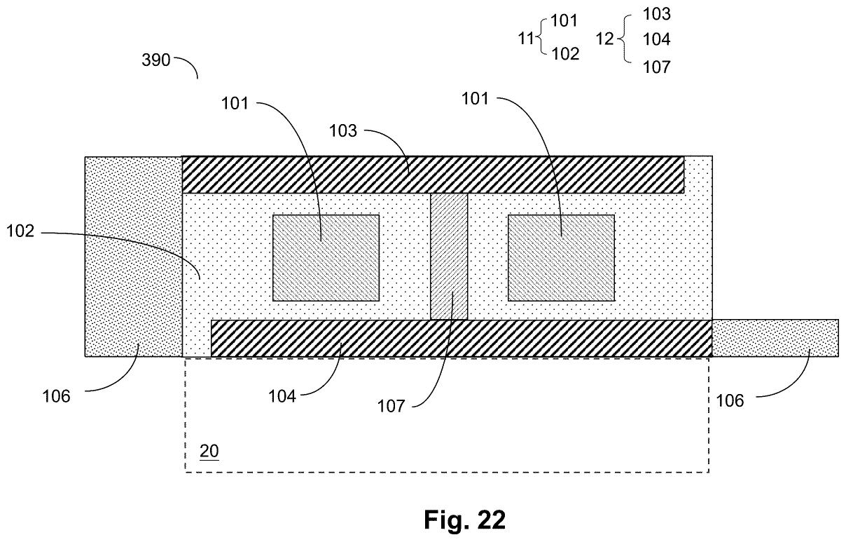

FIG. 22 illustrates an apparatus 390, where the frame 12 includes a top plate 103, a bottom plate 104, and a vertical frame with connecting bars 107. The frame's sides are connected to high thermally conductive objects 106 for heat dissipation. The connecting bars 107 are made of a material different from the top and bottom plates, enhancing the versatility of material selection for thermal management.

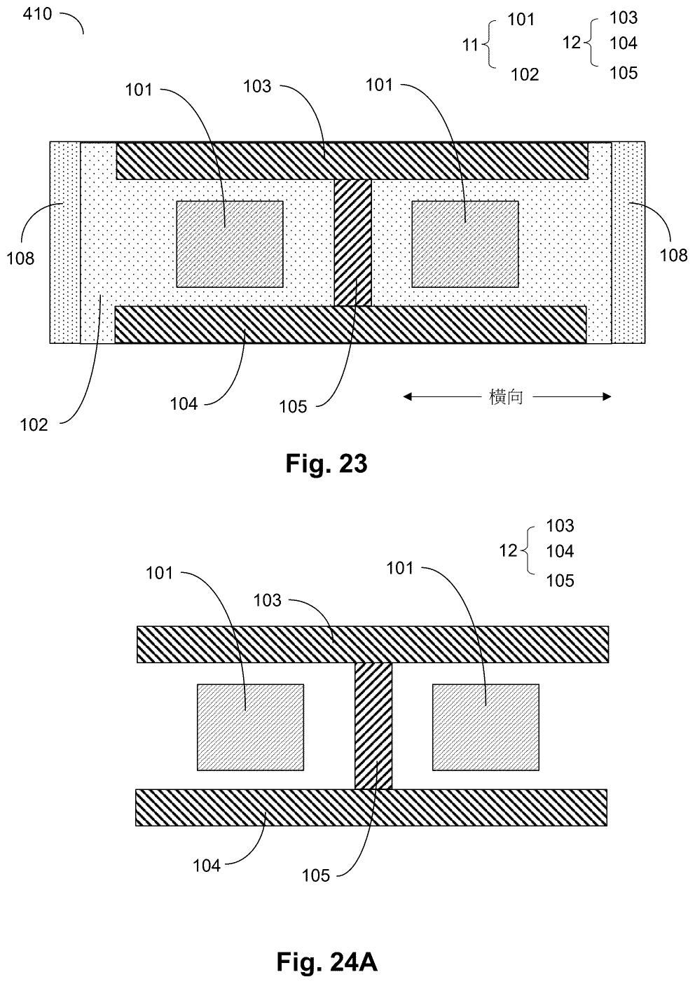

FIG. 23 depicts an apparatus 410 with a second magnetic powder material 108 encasing the first magnetic powder material 102 externally, as shown by arrows. The first magnetic powder material 102 determines the inductance of the inductor 11, while the second magnetic powder material 108 provides additional protection and heat dissipation. In one embodiment, the second magnetic powder material 108 and the structure comprising the first magnetic powder material 102, internal conductors 101, and frame 12 are integrally formed.

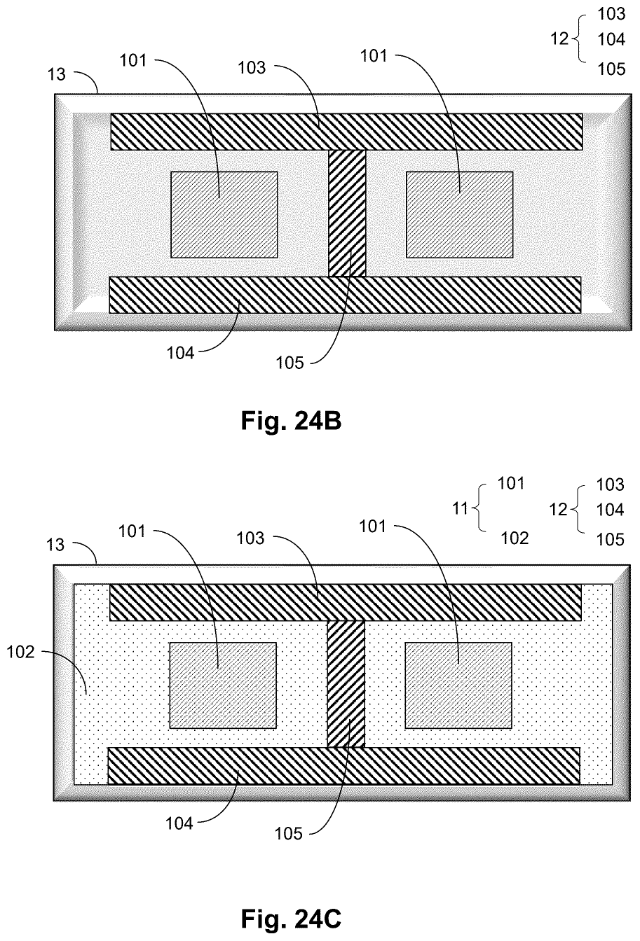

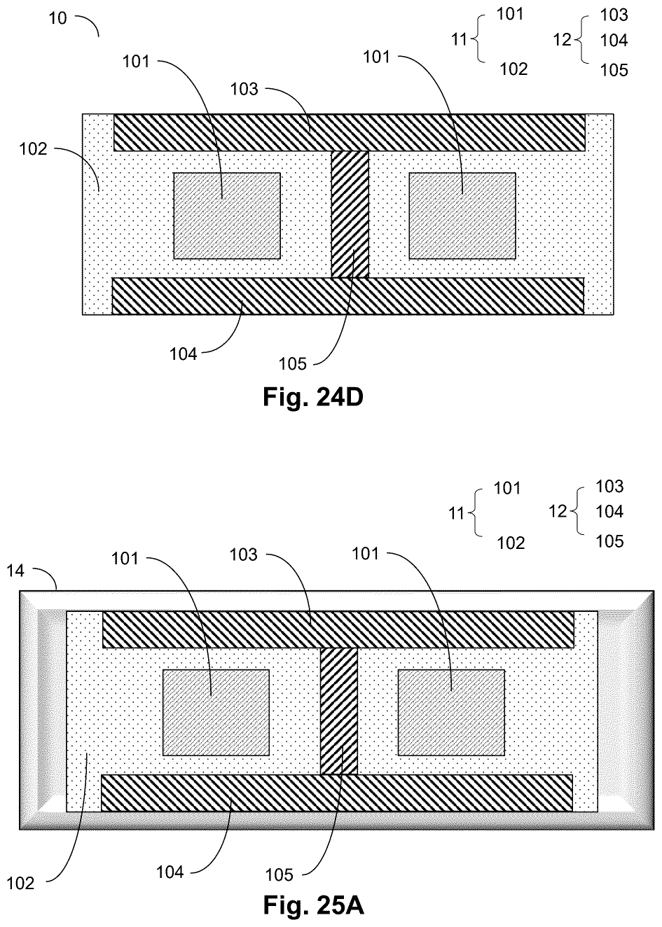

FIGS. 24A to 24D illustrate manufacturing steps of an apparatus 10 with an inductor and a high thermal conductivity frame. As shown in FIG. 24A, at least two internal conductors 101 and the frame 12 are provided. In FIG. 24B, these components are placed in a first mold 13. In FIG. 24C, the first magnetic powder material 102 is filled into the mold around the frame and internal conductors. The structure is then subjected to high-temperature and high-pressure processing to integrally form the inductor 11 and the frame 12. Finally, as shown in FIG. 24D, the structure is removed from the mold, completing the apparatus.

In one embodiment, the internal conductors 101 in FIG. 24A adopt a clip structure to reduce DC resistance.

In another embodiment, during the step shown in FIG. 24C, the frame 12 and the first magnetic powder material 102 are directly bonded without using thermal interface materials.

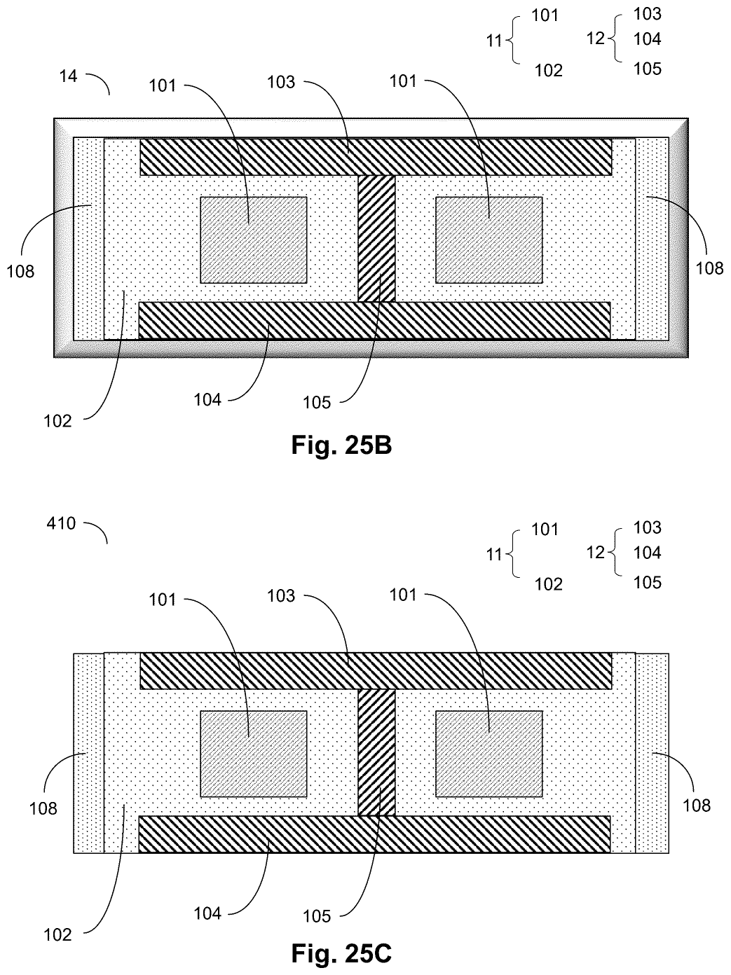

FIGS. 25A to 25C illustrate a method for manufacturing an apparatus 410 with an additional second magnetic powder material 108. Following the steps in FIGS. 24A to 24D, the structure is placed into a second mold 14 (FIG. 25A). The second magnetic powder material 108 is added around the first magnetic powder material 102 (FIG. 25B), and high-temperature and high-pressure processing is applied to form the final structure (FIG. 25° C.).

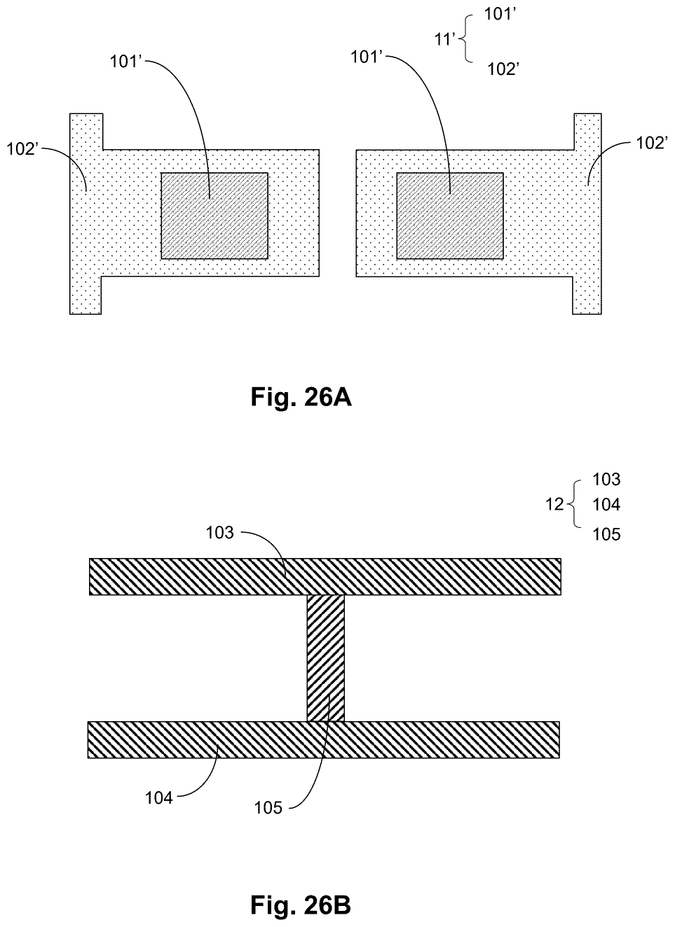

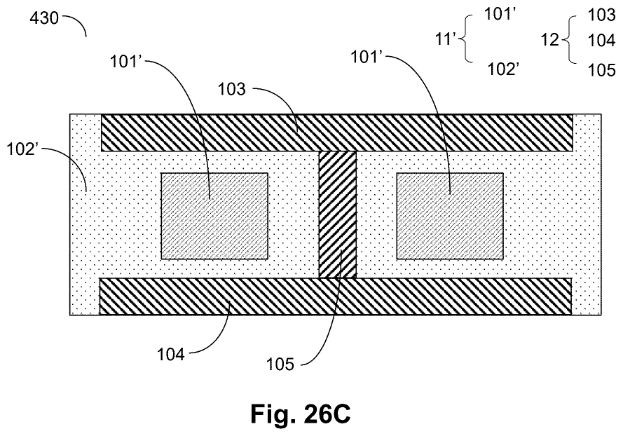

FIGS. 26A to 26C demonstrate a method for manufacturing an apparatus 430 by assembling sub-inductors. As shown in FIG. 26A, at least two sub-inductors 11′, each with internal conductors 101′ embedded in first magnetic powder materials 102′, are prepared. In FIG. 26B, a frame 12 with a top plate 103, a bottom plate 104, and vertical frames 105 is provided. Finally, the sub-inductors are assembled into the frame to form the apparatus, as shown in FIG. 26C.

In another embodiment, the apparatus 430 may incorporate the second magnetic powder material 108, as described in FIGS. 25A to 25C.

The present invention has been described in considerable detail with reference to certain preferred embodiments thereof. It should be understood that the description is for illustrative purpose, not for limiting the broadest scope of the present invention. Those skilled in this art can readily conceive variations and modifications within the spirit of the present invention. The various embodiments described above are not limited to being used alone; two embodiments may be used in combination, or a part of one embodiment may be used in another embodiment. For example, the frame may be arranged on a number of electronic components different from those shown in the figures, the order of placement of the frame and the sub-inductors may differ, or the shape of the frame may vary from that depicted in the figures. Therefore, in the same spirit of the present invention, those skilled in the art can think of various equivalent variations and various combinations, and there are many combinations thereof, and the description will not be repeated here. The scope of the present invention should include what are defined in the claims and the equivalents.

What is claimed is:

1. An apparatus having an inductor and a high thermal conductivity frame, comprising:
an inductor having at least two internal conductors, the inductor being embedded in a first magnetic powder material; and
a frame made of a high thermal conductivity material, the frame including a top plate located above the at least two internal conductors, a bottom plate located below the at least two internal conductors, and at least one vertical frame between the top plate and the bottom plate, the frame being embedded within the first magnetic powder material;
wherein the apparatus is disposed above an electronic component and is in contact with the electronic component through the bottom plate of the frame.

2. The apparatus of claim 1, wherein one of the at least one vertical frame includes one of the following forms:
the vertical frame is connected between the top plate and the bottom plate, and the vertical frame, the top plate, and the bottom plate are integrally formed;
the vertical frame includes a connecting bar, the connecting bar being connected between the top plate and the bottom plate;
the vertical frame includes an upper vertical frame integrally formed with the top plate and a lower vertical frame integrally formed with the bottom plate, wherein the upper vertical frame and the lower vertical frame are either directly connected or separated by a gap, the gap being less than one-fourth of a vertical distance between the top plate and the bottom plate;
the vertical frame includes an upper vertical frame integrally formed with the top plate and a lower vertical frame integrally formed with the bottom plate, wherein the upper vertical frame and the lower vertical frame are connected by a connecting bar;
wherein the connecting bar is made of a high thermal conductivity material.

3. The apparatus of claim 1, wherein the high thermal conductivity material is a formable metal, including steel, copper, silver, gold, aluminum, tungsten, zinc, or stainless steel.

4. The apparatus of claim 1, wherein the high thermal conductivity material is a non-metallic material, including aluminum nitride, silicon carbide, or graphite.

5. The apparatus of claim 1, wherein the frame is coplanar with or does not extend beyond the surface of the first magnetic powder material of the inductor.

6. The apparatus of claim 1, wherein the frame extends beyond the surface of the first magnetic powder material of the inductor.

7. The apparatus of claim 1, wherein the surface of the top plate is connectable to a high thermal conductivity object through a thermal interface material to enhance heat dissipation.

8. The apparatus of claim 1, wherein the electronic component includes an integrated circuit chip, an inductor, a capacitor, or a resistor.

9. The apparatus of claim 1, wherein a side of the frame is optionally connected to at least one high thermal conductivity object for heat dissipation.

10. The apparatus of claim 9, wherein the at least one high thermal conductivity object is connected to the top plate or the bottom plate.

11. The apparatus of claim 1, wherein the frame is embedded within the first magnetic powder material, and the top plate, bottom plate, and vertical frame of the frame are directly in contact with the first magnetic powder material without using a thermal interface material.

12. The apparatus of claim 11, wherein the frame is manufactured through a single molding process, with the top plate, bottom plate, and vertical frame directly bonded to the first magnetic powder material under high temperature and high pressure.

13. The apparatus of claim 1, wherein the frame includes multiple vertical frames connecting the top plate and the bottom plate to enhance structural strength.

14. The apparatus of claim 1, wherein the internal conductor of the inductor is a clip structure to reduce direct current resistance.

15. The apparatus of claim 1, wherein the length or width of the top plate and the bottom plate of the frame are optionally to be the same or different to optimize heat dissipation performance.

16. The apparatus of claim 1, wherein the vertical frame is located in the middle portion of the inductor, contacting the top plate and the bottom plate, and providing a heat conduction path to transfer heat from the middle portion of the inductor to the top plate and the bottom plate.

17. The apparatus of claim 1, wherein the frame is directly embedded within the first magnetic powder material during a manufacturing process of the inductor, without using a metallic sheet to cover the inductor after its formation, thereby avoiding uneven or excessive gaps caused during a covering process and improving heat dissipation performance.

18. The apparatus of claim 1, further comprising:
a second magnetic powder material, the second magnetic powder material covering the external structure of the first magnetic powder material, the internal conductors, and the frame.

19. The apparatus of claim 18, wherein the first magnetic powder material and the second magnetic powder material are two different magnetic powders, the first magnetic powder material being used to determine inductance of the inductor, and the second magnetic powder material being used for outer layer protection and heat dissipation.

20. A method for manufacturing an apparatus having an inductor and a high thermal conductivity frame, the apparatus including an inductor having at least two internal conductors, and a frame made of a high thermal conductivity material, the frame including a top plate located above the at least two internal conductors, a bottom plate located below the at least two internal conductors, and at least one vertical frame between the top plate and the bottom plate, the frame being embedded in a magnetic powder material and directly in contact with the magnetic powder material, the method comprising:
(a) providing the at least two internal conductors and the frame;
(b) placing the at least two internal conductors and the frame in a first mold, positioning the at least two internal conductors with the top plate, the bottom plate, and the vertical frame of the frame at predetermined positions;
(c) adding a first magnetic powder material into the first mold, filling the first magnetic powder material between the frame and the internal conductors;
(d) performing high-temperature and high-pressure treatment on the first mold, integrally forming the first magnetic powder material, the internal conductors, and the frame into a structure embedded within the first magnetic powder material; and
(e) removing the formed structure from the first mold to produce the apparatus having an inductor and a high thermal conductivity frame.

21. The method of claim 20, wherein in step (a), the internal conductor is a clip structure to reduce direct current resistance.

22. The method of claim 20, further comprising:
(f) placing the structure in a second mold, positioning the structure at a predetermined position;
(g) adding a second magnetic powder material into the second mold, filling the second magnetic powder material around the structure; and
(h) performing high-temperature and high-pressure treatment on the second mold to integrally form the second magnetic powder material and the structure, thereby producing the apparatus having an inductor and a high thermal conductivity frame.

23. The method of claim 22, wherein the first magnetic powder material and the second magnetic powder material are two different magnetic powders, the first magnetic powder material being used to determine inductance of the inductor, and the second magnetic powder material being used for outer layer protection and heat dissipation.

24. The method of claim 20, wherein one of the at least one vertical frame includes one of the following forms:
the vertical frame is connected between the top plate and the bottom plate, and the vertical frame, the top plate, and the bottom plate are integrally formed;
the vertical frame includes a connecting bar, the connecting bar being connected between the top plate and the bottom plate;
the vertical frame includes an upper vertical frame integrally formed with the top plate and a lower vertical frame integrally formed with the bottom plate, wherein the upper vertical frame and the lower vertical frame are either directly connected or separated by a gap, the gap being less than one-fourth of a vertical distance between the top plate and the bottom plate;
the vertical frame includes an upper vertical frame integrally formed with the top plate and a lower vertical frame integrally formed with the bottom plate, wherein the upper vertical frame and the lower vertical frame are connected by a connecting bar;
wherein the connecting bar is made of a high thermal conductivity material.

25. The method of claim 20, wherein the high thermal conductivity material is a formable metal, including steel, copper, silver, gold, aluminum, tungsten, zinc, or stainless steel.

26. The method of claim 20, wherein the high thermal conductivity material is a non-metallic material, including aluminum nitride, silicon carbide, or graphite.

27. The method of claim 20, wherein in step (d), the frame is directly bonded to the first magnetic powder material without using a thermal interface material.

28. The method of claim 20, wherein the length or width of the top plate and the bottom plate of the frame can be the same or different to optimize heat dissipation performance.

29. The method of claim 20, wherein in step (b), the frame includes multiple vertical frames connecting the top plate and the bottom plate to enhance structural strength.

30. The method of claim 20, wherein after step (e), the top surface of the inductor is connectable to a high thermal conductivity object through a thermal interface material.

31. A method for manufacturing an apparatus having an inductor and a high thermal conductivity frame, the apparatus including at least two internal conductors and a frame made of a high thermal conductivity material, the frame including a top plate above the internal conductors, a bottom plate below the internal conductors, and at least one vertical frame between the top plate and the bottom plate, the frame being embedded in a magnetic powder material and directly in contact with the magnetic powder material, the method comprising:
(a) manufacturing at least two separate sub-inductors, each having at least one internal conductor embedded in a first magnetic powder material;
(b) providing the frame; and
(c) assembling the at least two sub-inductors into the frame, positioning the top plate and the bottom plate on the upper and lower sides of the at least two sub-inductors, respectively, to form a structure, thereby producing the apparatus having an inductor and a high thermal conductivity frame.

32. The method of claim 31, further comprising:
(d) placing the structure in a mold, positioning the structure at a predetermined position;
(e) adding a second magnetic powder material into the mold, filling the second magnetic powder material around the structure; and
(f) performing high-temperature and high-pressure treatment on the mold to integrally form the second magnetic powder material and the structure, thereby producing the apparatus having an inductor and a high thermal conductivity frame.

33. The method of claim 31, wherein in step (c), the frame is connected to at least two sub-inductors through an adhesive or a thermal interface material.

34. The method of claim 31, wherein the first magnetic powder material and the second magnetic powder material are two different magnetic powders, the first magnetic powder material being used to determine inductance of the inductor, and the second magnetic powder material being used for outer layer protection and heat dissipation.

35. The method of claim 31, wherein one of the at least one vertical frame includes one of the following forms:
the vertical frame is connected between the top plate and the bottom plate, and the vertical frame, the top plate, and the bottom plate are integrally formed;
the vertical frame includes a connecting bar, the connecting bar being connected between the top plate and the bottom plate;
the vertical frame includes an upper vertical frame integrally formed with the top plate and a lower vertical frame integrally formed with the bottom plate, wherein the upper vertical frame and the lower vertical frame are either directly connected or separated by a gap, the gap being less than one-fourth of a vertical distance between the top plate and the bottom plate;
the vertical frame includes an upper vertical frame integrally formed with the top plate and a lower vertical frame integrally formed with the bottom plate, wherein the upper vertical frame and the lower vertical frame are connected by a connecting bar;
wherein the connecting bar is made of a high thermal conductivity material.
